(19) United States
(12) Patent Application Publication
(10) Pub. No.: US 2017/0331688 A1
(43) Pub. Date: Nov. 16, 2017

(54) Method Performed by a WLAN Node in an Integrated Wireless Communications Network, for Applying Security to Received Traffic Data

(71) Applicant: Telefonaktiebolaget LM Ericsson (publ), Stockholm (SE)

(72) Inventors: Filip Mestanov, Sollentuna (SE); Karl Norrman, Stockholm (SE); Oumer Teyeb, Solna (SE)

(21) Appl. No.: 15/531,239

(22) PCT Filed: Dec. 4, 2014
(86) PCT No.: PCT/SE2014/051447

§ 371 Date: May 26, 2017

(51) Int. Cl. H04L 12/24; H04W 84/12; H04W 12/06; H04W 88/06; H04L 29/06

(52) U.S. Cl. CPC H04L 41/0836; H04W 88/06; H04L 63/20; H04W 12/06; H04W 84/12

(57) ABSTRACT

A wireless local area network, WLAN, node (400) is adapted to be comprised in an integrated wireless communications network comprising a WLAN and a cellular communications network. The WLAN node (400) comprises a receiving module (401) adapted to receive traffic data signals from a wireless device. A security module (403) is adapted to process the received traffic data signals and apply a first security protocol to a first traffic data signal received from the wireless device and a second security protocol to a second traffic data signal received from the wireless device. A routing module (405) is adapted to route the first traffic data signal to a node of the cellular communications network and route the second traffic data signal to a node of the WLAN. In one example the the security module is adapted to concurrently process the first traffic data signal and second traffic data signal from the wireless device, and the routing module (405) is adapted to concurrently route the first traffic data signal and the second traffic data signal to their respective nodes.

### TECHNICAL FIELD

The embodiments of the present invention relate to a Wireless Local Area Network (WLAN) node, a wireless device and to methods therein, and in particular to how they relate to being adapted for use in an integrated wireless communications network comprising, for example, a WLAN and a cellular communications network.

### BACKGROUND

Most current Wireless Local Area Networks, WLAN, or Wi-Fi networks (WLAN and Wi-Fi being used interchangeably in the remainder of this document) are networks that exist totally separate from cellular or mobile communication networks, and can be seen as non-integrated from the perspective of a terminal or user equipment.

Most operating systems (OSs) used in user equipment, for example Android™ and iOS®, support a simple Wi-Fi offloading mechanism whereby a user equipment can immediately switch all its IP traffic to a Wi-Fi network upon the detection of a suitable network with a received signal strength above a certain level. The decision about whether or not to offload to a Wi-Fi network is referred to as an access selection strategy, and the term “Wi-Fi-if-coverage” is used to refer to the aforementioned strategy of selecting a Wi-Fi network whenever such a network is detected. There are several drawbacks of the “Wi-Fi-if-coverage” strategy.

For example, although a user can save previous pass codes for already accessed Wi-Fi Access Points (APs), hotspot login for previously non-accessed APs usually requires user intervention, either by entering the pass code using a Wi-Fi connection manager or using a web interface. The connection manager is software on a user device that is in charge of managing the network connections of the terminal, taking into account user preferences, operator preferences, network conditions, and so on.

A drawback of the Wi-Fi-if-coverage strategy is that no consideration is made of expected user experience, except those considered in a user equipment implemented proprietary solution, and this can lead to a user equipment being handed over from a high data rate mobile network connection to a low data rate Wi-Fi connection. Even though the operating system of a user equipment, or some high level software, is intelligent enough to make the offload decisions only when the signal level on the Wi-Fi is considerably better than the mobile network link, there can still be limitations on the backhaul of the Wi-Fi Access Point (AP) that may end up being a bottleneck.

Another drawback of the Wi-Fi-if-coverage strategy is that no consideration is made of the respective load conditions in the mobile network and Wi-Fi network. As such, a user equipment might still be offloaded to a Wi-Fi access point that is serving several user equipment, while the mobile network (e.g. LTE), to which it was previously connected to, is rather unloaded.

In addition, the Wi-Fi-if-coverage strategy can lead to interruptions of on-going services, for example due to the change of IP address when a user equipment switches to the Wi-Fi network. For example, a user who started a Voice over IP (VoIP) call while connected to a mobile network is likely to experience a call drop when arriving home and the user equipment switches to the Wi-Fi network automatically. Although some applications, for example Spotify®, are intelligent enough to handle this and survive the change of IP address, the majority of current applications cannot. This can place a burden on application developers if they have to ensure service continuity.

Yet a further drawback of the Wi-Fi-if-coverage strategy is that no consideration about the mobility of the user equipment is made. Due to this, a fast moving user equipment can end up being offloaded to a Wi-Fi access point for a short duration, just to be handed back over to the mobile network. This is a particular problem in scenarios such as cafes with open Wi-Fi, where a user walking by or even driving by the cafe might be affected by this. Such ping pong between the Wi-Fi and mobile networks can cause service interruptions as well as generate considerable unnecessary signaling (e.g. towards authentication servers).

Recently, Wi-Fi has been subject to increased interest from cellular network operators, not only as an extension to fixed broadband access, but also in connection with using the Wi-Fi technology as an extension, or alternative to cellular radio access network technologies to handle the always increasing wireless bandwidth demands.

At present, a WLAN node, such as an access point, has limitations when handling traffic data from a user equipment that comprises both WLAN type traffic data (such as local breakout traffic) and cellular type traffic data (such as aggregation traffic).

### SUMMARY

It is an aim of the present invention to provide a method and apparatus which obviate or reduce at least one or more of the disadvantages mentioned above.

According to a first aspect of the present invention there is provided a wireless local area network, WLAN, node adapted to be comprised in an integrated wireless communications network comprising a WLAN and a cellular communications network. The WLAN node comprises a receiving module adapted to receive traffic data signals from a wireless device. The WLAN node comprises a security module adapted to process the received traffic data signals and apply a first security protocol to a first traffic data signal received from the wireless device and a second security protocol to a second traffic data signal received from the wireless device. The WLAN node further comprises a routing module adapted to route the first traffic data signal to a node of the cellular communications network and route the second traffic data signal to a node of the WLAN.

According to another aspect of the present invention there is a method in a wireless local area network, WLAN, node adapted to be comprised in an integrated wireless communications network comprising a WLAN and a cellular communications network. The method comprises the steps of receiving traffic data signals from a wireless device. The received traffic data signals are processed, and a first security protocol applied to a first traffic data signal received from the wireless device and a second security protocol applied to a second traffic data signal received from the wireless device. The first traffic data signal is routed to a node of the cellular communications network and the second traffic data signal routed to a node of the WLAN.

According to another aspect of the present invention, there is provided a wireless device comprising a communication module adapted to communicate traffic data signals with a wireless local area network, WLAN, node. The communication module is adapted to communicate a first traffic data signal using a first security protocol; and communicate a second traffic data signal using a second security protocol.

According to another aspect of the present invention, there is provided a method in a wireless device. The method comprises the steps of communicating traffic data signals with a wireless local area network, WLAN, node, wherein the traffic data signals comprise a first traffic data signal corresponding to traffic for a cellular communications network, and a second traffic data signal for a WLAN. The first traffic data signal is communicated using a first security protocol, and the second traffic data signal communicated using a second security protocol.

### BRIEF DESCRIPTION OF THE DRAWINGS

For a better understanding of examples of the present invention, and to show more clearly how the examples may be carried into effect, reference will now be made, by way of example only, to the following drawings in which:

FIG. 1(a) illustrates an example of aggregation between a cellular communication network and Wireless Local Area Network, WLAN, at a Packet Data Convergence Protocol, PDCP, level;

FIG. 1(b) illustrates an example of aggregation between a cellular communication network and WLAN at an Radio Link Control, RLC protocol level;

FIG. 1(c) illustrates an example of aggregation between a cellular communication network and WLAN at a Medium Access Control, MAC, protocol level;

FIG. 2 illustrates an example of PDCP level aggregation with a standalone access point, AP, and standalone eNB;

FIG. 3 (comprising FIGS. 3a, 3b and 3c) describes an example of a process flow relating to WLAN that is configured to provide Robust Secure Network, RSN, authentication;

FIG. 4 shows an example of a WLAN node according to an embodiment of the present invention;

FIG. 5 shows an example of a method according to an embodiment of the present invention;

FIG. 6 shows an example of a wireless device according to an embodiment of the present invention;

FIG. 7 shows an example of a method in a wireless device, according to an embodiment of the present invention;

FIG. 8a shows an example of a method in a wireless device, according to an embodiment of the present invention;

FIG. 8b shows an example of a method in a wireless device, according to an embodiment of the present invention;

FIG. 9a describes an example of a process flow relating to WLAN that is configured to support a legacy wireless device using a first security protocol (e.g. RSN) only, and a wireless device according to an embodiment of the present invention using first and second security protocols concurrently;

FIG. 9b describes an example of a process flow relating to WLAN that is configured to support a wireless device according to an embodiment of the present invention using first and second security protocols concurrently;

FIG. 9c describes another example of a process flow relating to WLAN that is configured to support a wireless device according to an embodiment of the present invention using first and second security protocols concurrently; and

FIG. 10 shows an example of a network comprising a WLAN node and a wireless device according to an embodiment of the present invention.

### DETAILED DESCRIPTION

As mentioned above in the background section, Wi-Fi has recently been subject to increased interest from cellular network operators, not only as an extension to fixed broadband access, but also in connection with using the Wi-Fi technology as an extension, or alternative to cellular radio access network technologies to handle the always increasing wireless bandwidth demands. Cellular operators that are currently serving mobile users with, for example, any of the 3GPP technologies, such as LTE, UMTS/WCDMA, or GSM, consider Wi-Fi as a wireless technology that can support their regular cellular communication networks. The term “operator-controlled Wi-Fi” points to a Wi-Fi deployment that on some level is integrated with an existing cellular network operator, and where the 3GPP radio access networks and the Wi-Fi wireless network access may even be connected to the same core network and provide the same services.

There is currently quite intense activity in the area of operator-controlled Wi-Fi in several standardization organizations. In 3GPP, activities to connect Wi-Fi access points to the 3GPP-specified core network are being pursued, and in the Wi-Fi alliance, WFA, activities related to certification of Wi-Fi products are undertaken, which to some extent is also driven from the need to make Wi-Fi a viable wireless technology for cellular operators to support high bandwidth offerings in their networks. The term Wi-Fi offload is commonly used and points towards the notion of cellular network operators seeking to offload traffic from their cellular networks to Wi-Fi, for example during peak traffic times, and in situations when the cellular network, for one reason or another, needs to be off-loaded, for example to provide a requested quality of service, to maximize bandwidth or simply for coverage.

Radio Access Network (RAN) level integration is also being proposed. 3GPP is currently working on specifying a feature/mechanism for WLAN/3GPP Radio interworking which improves operator control with respect to how a user equipment performs access selection and traffic steering between 3GPP and WLANs belonging to the operator or its partners.

It is discussed that for this mechanism the RAN provides assistance parameters that assist a user equipment with the access selection. The RAN assistance information is composed of three main components, namely threshold values, an offloading preference indicator (OP I) and WLAN identifiers. A user equipment is also provided with RAN rules or policies that make use of these assistance parameters.

The threshold values can be used, for example, for metrics such as 3GPP signal related metrics, for example: Reference Signal Received Power (RSRP), Reference Signal Received Quality (RSRQ), Received Signal Code Power (RSCP), Energy per chip over the Noise (EcNo), and/or WLAN signal related metrics such as Received Channel Power Indicator (RCPI), Received Signal Strength Indicator (RSSI), WLAN load/utilization, WLAN backhaul load/capacity, and so on. One example of a RAN rule that uses the threshold value could be that a user equipment should connect to a WLAN if the RSRP is below the signaled RSRP threshold, while at the same time the WLAN RCPI is above the signaled RCPI threshold (it is also discussed that the RAN should provide thresholds for when the user equipment should steer traffic back from WLAN to 3GPP). The RAN rules/policies are expected to be specified in a 3GPP specification such as TS 36.304 v12.0.0 and/or TS 36.331 v12.1.0.

With a mechanism such as the above, it might not be wanted, or maybe not even feasible, that the terminal considers any WLAN when deciding where to steer traffic. For example, it may not be feasible that the terminal uses this mechanism to decide to steer traffic to a WLAN which does not belong to the operator. Hence it has been proposed that the RAN should also indicate to the terminal which WLANs the mechanism should be applied for, by sending WLAN identifiers.

The RAN may also provide additional parameters which are used in Access Network Discovery and Selection Function (ANDSF) policies. One proposed parameter is the offloading preference indicator (OPI). One possibility for OPI is that it is compared to a threshold in the ANDSF policy to trigger different actions. Another possibility is that OPI is used as a pointer to point, and select, different parts of the ANDSF policy which would then be used by the terminal.

The RAN assistance parameters (i.e. thresholds, WLAN identifiers, OPI) provided by RAN may be provided with dedicated signaling and/or broadcast signaling. Dedicated parameters can only be sent to the terminal when having a valid Radio Resource Control, RRC, connection to the 3GPP RAN. A terminal which has received dedicated parameters applies dedicated parameters; otherwise the terminal applies the broadcast parameters. If no RRC connection is established between the terminal and the RAN, the terminal cannot receive dedicated parameters.

In 3GPP, it has been agreed that ANDSF should be enhanced for release-12 to use the thresholds and OPI parameters that are communicated by the RAN to the user equipment, and that if enhanced ANDSF policies are provided to the user equipment, the user equipment will use the ANDSF policies instead of the RAN rules/policies (i.e. ANDSF has precedence).

Within the scope of 3GPP release-13, there has been a growing interest in realizing even tighter integration/aggregation between 3GPP and WLAN (for example, in a similar way as carrier aggregation between multiple carriers in 3GPP, where the WLAN is used just as another carrier). Such an aggregation is expected to make it possible for a more optimal aggregation opportunity as compared to Multipath Transmission Control Protocol, MPTCP, as the aggregation is performed at a lower layer and as such the scheduling and flow control of the data on the WLAN and 3GPP links can be controlled by considering dynamic radio network conditions.

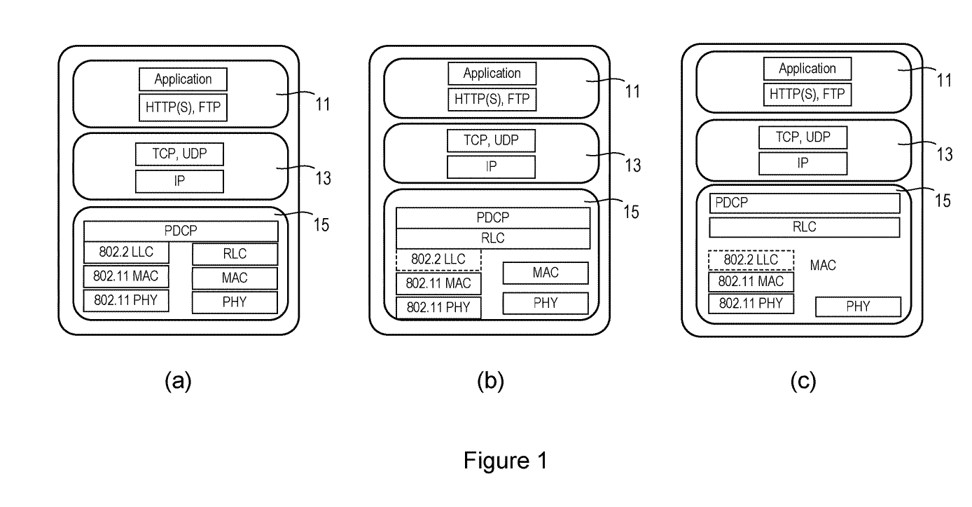

FIGS. 1(a), 1(b) and 1(c) illustrate different levels of integration or aggregation between a cellular communications network (such as 3GPP) and WLAN, and in particular three different protocol options of aggregation at the Packet Data Convergence Protocol (PDCP), Radio Link Control (RLC) and Medium Access Control, MAC, levels, respectively.

FIGS. 1(a), 1(b) and 1(c) show the main principles for these three examples of aggregation levels, although additional functionality may be needed. For example, in the PDCP level aggregation, an additional protocol layer may be used between the PDCP layer and the 802.2 Logical Link Control, LLC, layer to convey information about the user equipment and the radio bearer the traffic is associated with.

It is noted that FIGS. 1(a), 1(b) and 1(c) show the protocol stack at a UE or an integrated/co-located eNB-WLAN access point station. In the case of a standalone access point and eNB (i.e. whereby the access point and eNB are not co-located), the protocol stack for supporting aggregation may be different, as the LLC frames have to be relayed towards a standalone eNB in such a scenario.

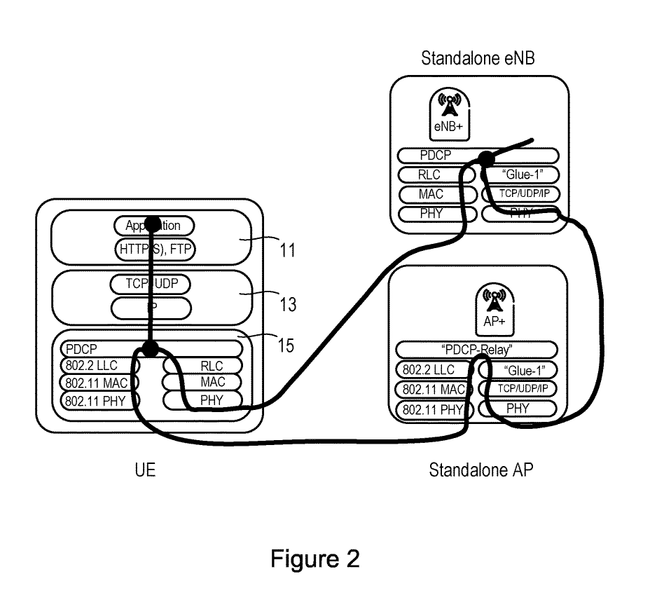

FIG. 2 is an example illustrating this for the case of PDCP level aggregation.

In this case, once the LLC packet is decoded at an access point (in the uplink direction from a user equipment to the access point), and the access point realizes that this packet is a PDCP packet that has to be routed to an eNB, the forwarding can be performed via normal TCP/IP protocol stack.

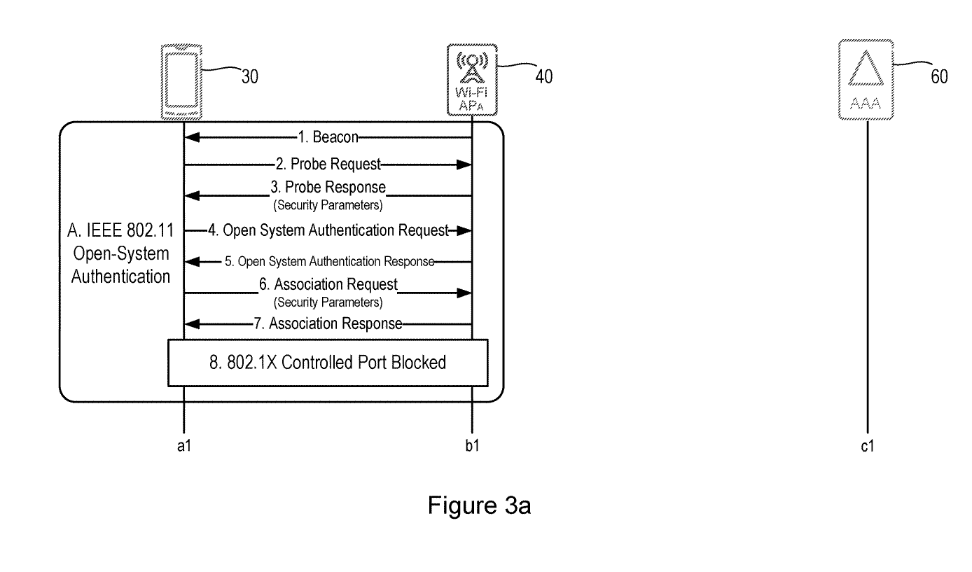

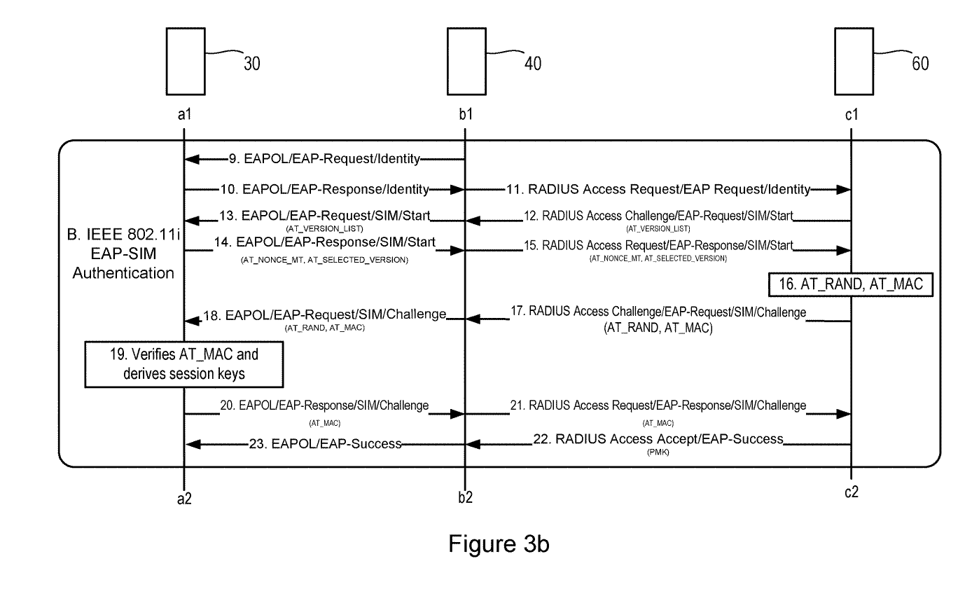

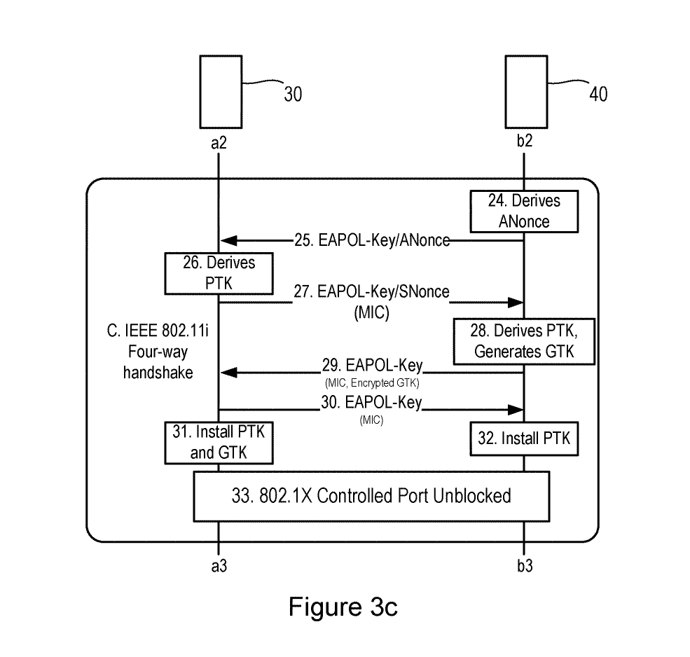

By way of further background, FIGS. 3(a), 3(b) and 3(c) illustrate an example of user equipment attachment and authentication procedures in a WLAN.

The authentication procedure for a user equipment (UE) or station (STA) 30 connecting to a WLAN access point (AP) 40 that employs Robust Security Network, RSN, authentication is depicted in FIGS. 3(a), 3(b) and 3(c).

The authentication procedure comprises the following steps.

Referring in the first instance to FIG. 3a:

Step 1—The STA 30 receives a Beacon frame revealing (among other parameters) the security features associated with the ESS the AP 40 belongs to. The format of the beacon frame as well as all the information elements it carries are described in Chapter 8.3.3.2 of IEEE 802.11, Part 11: “Wireless LAN Medium Access Control (MAC) and Physical Layer (PHY) Specifications”, IEEE Std. 802.11-2012, IEEE Computer Society;

Step 2—If the STA 30 does not receive a Beacon frame for some reason, it can generate a Probe Request and send it to the AP 40. This procedure is called active scanning and by performing it, the STA 30 can receive from the AP 40 the same information as it would have from a Beacon message. The Probe Request frame is described in Chapter 8.3.3.9 of IEEE 802.11 (Part 11, as specified above);

Step 3—The AP 40 answers with Probe Response—IEEE 802.11 (Part 11, as specified above), Chapter 8.3.3.10; It is noted that the discovery procedure consists of either step 1 or steps 2 and 3 (i.e., receiving a Beacon frame and exchanging probe messages are mutually exclusive);

Step 4—The STA 30 sends an Open System Authentication Request as defined in Chapter 11.2.3.2 of IEEE 802.11 (Part 11, as specified above);

Step 5—The AP 40 responds with an Open System Authentication Response;

Step 6—The STA 30 then sends an Association Request, indicating the security parameters to be used later;

Step 7—The AP 40 responds with an Association Response. It is noted that the Open System Authentication does not provide any security. The connection between the STA 30 and the AP 40 is secured at a later point, by means of Authentication and Key Agreement procedure. Nevertheless, a possible attack altering the security parameters in the Open System Authentication message exchange will be detected at the stage of key derivation;

Step 8—At this point the Open System Authentication is completed and the STA 30 can communicate only with the AP 40—the rest of the traffic is blocked by the port-based network control (PBNC) enforcer, as defined in IEEE 802.1X. Some of the traffic towards external hosts, however, can be forwarded by the AP 40, as in the case of the communication with a RADIUS server;

Continuing onto FIG. 3b:

Step 9—This step is the first step of the Extensible Authentication Protocol Subscriber Identity Module (EAP-SIM) authentication, as described further in the Internet Engineering Task Force, IETF, RFC 4186. The AP 40 encapsulates an EAP-Request of Type 18 (SIM) inside an EAP-over-LAN (EAPOL) frame, asking the STA 30 to report its identity. In the case when the STA 30 is equipped with a SIM, the identity is the International Mobile Subscriber Identity (IMSI), followed by the “@” sign and the home realm. It is also possible for the STA 30 to include an additional “1” in front of the IMSI in order to indicate preference for the exclusive use of EAP-SIM if other EAP methods are available (e.g., EAP-AKA);

Step 10—The STA 30 responds with its identity. An example of such is: 1234580123000100@wlan.mnc048.mcc264.3gppnetwork.org (and IMSI is in this example 234580123000100 and the preceding “1” indicates the preference to use EAP-SIM);

Step 11—The AP 40 extracts the EAP-Response message, encapsulates it in a RADIUS frame and forwards it to the backend AAA server 60, for example part of a cellular architecture. The handling of EAP frames over RADIUS is described further by the IETF in RFC 3579;

Step 12—The AAA server 60 recognizes the EAP method and sends an EAP-Request/SIM/Start, indicating that an EAP-SIM procedure has been initiated for that Supplicant. It also includes the list of supported SIM versions in the message as described in Chapter 10.2 of RFC 4186;

Step 13—The AP 40 relays the EAP-Request/SIM/Start message to the STA 30;

Step 14—The STA 30 responds with EAP-Response/SIM/Start message, which carries a random number (NONCE_MT) carried in the AT_NONCE_MT attribute (a randomly selected number), as well as the selected EAP-SIM version (AT_SELECTED_VERSION);

Step 15—The AP 40 forwards the EAP-Response/SIM/Start to the AAA server 60;

Step 16—The AAA server 60 obtains the GSM triplet (RAND, SRES and Kc) from the HLR/AuC and derives the keying material as specified in Chapter 7 of RFC 4186. The GSM triplet consists of:
a) RAND—a 128-bit random number, generated by the Authentication Center (an entity within the GSM core network, used to authenticate subscribers at the point of initial attach) when a subscriber authentication is requested. Its main use is for the derivation of the Signed Response (SRES) and the Kc;
b) SRES—a 32-bit variable, the expected response from the mobile station/STA 30 after it has been challenged with the RAND;
c) Kc—a 64-bit ciphering key, used to encipher and decipher data transmitted between the STA 30 and the AP 40;

Step 17—The AAA server 60 generates an EAP-Request/SIM/Challenge message, including RAND challenges and message authentication code attribute (AT_MAC). The AT_MAC derivation is based on the RAND and Kc values;

Step 18—The AP 40 forwards the EAP-Request/SIM/Challenge message to the STA 30;

Step 19—The STA 30 feeds the received RAND into the GSM algorithms running on the SIM and the output is a copy of the AT_MAC and a SRES value. The first thing for the STA 30 to do is to check whether the AT_MAC value received by the AAA (relayed by the AP) and the one generated by the SIM match. If so the STA continues with the authentication, otherwise it responds with an EAP-Response/SIM/Client-Error message. The second thing is to derive a new AT_MAC, based on the generated SRES;

Step 20—The new AT_MAC is sent to the AAA server 60 (via the AP 40) in an EAP-Response/SIM/Challenge message;

Step 21—The AP 40 forwards the EAP-Response/SIM/Challenge to the AAA server 60;

Step 22—The AAA server 60 verifies the new AT_MAC value that the STA 30 has just sent. If the verification is successful, it sends an EAP-Success message to the AP 40. The message also carries keying material—Pairwise Master Key (PMK). The PMK is intended for the AP 40 only and it is not forwarded to the STA 30 (the STA 30 can derive the same key autonomously since it is based on the Kc, which the SIM in the STA 30 can compute based on the RAND);

Step 23—The AP 40 forwards the EAP-Success message to the STA 30 and stores the PMK for the following Four-way handshake;

Continuing onto FIG. 3c:

Step 24—The AP 40 uses the PMK to generate an Authenticator nonce (ANonce);

Step 25—The ANonce value is sent to the STA 30 in an EAPOL-Key message;

Step 26—Using the received ANonce (together with the SNonce and the PMK), the STA 30 constructs the Pairwise Temporal Key (PTK);

Step 27—The STA 30 sends an EAPOL-Key message to the AP 40, including a Supplicant nonce (SNonce) and a message integrity code (MIC);

Step 28—The AP 40 uses the ANonce, SNonce and the PMK to construct the PTK. The AP 40 also uses the MIC in order to verify that the STA 30 has computed the correct and fresh key. Furthermore, the AP 40 also generates and installs a Group Temporal Key (GTK, which is used exclusively for the encryption and decryption of broadcast and multicast traffic;

Step 29—The AP 40 sends to the STA 30 an encrypted GTK, a sequence number to use for the next broadcast message and an instruction to install the PTK (the message is integrity protected by another MIC);

Step 30—The STA 30 responds with an acknowledgement message;

Step 31—The STA 30 installs both the PTK and the GTK and as of this point uses them to encrypt and decrypt all communication;

Step 32—The AP 40 also installs the PTK;

Step 33—The 802.1X Controlled Port is now open and the STA 30 can communicate with other network hosts besides the AP 40.

In some situations, WLAN network nodes (e.g. Access Points 40) will need to support both aggregation traffic and local breakout traffic simultaneously from the same user equipment or station, (aggregation traffic, for example, being traffic that forms part of traffic intended for a cellular network, and local breakout traffic, for example, being traffic that is for use in the WLAN).

For example, currently some proposals for WLAN systems used for access aggregation with 3GPP may not use WLAN security mechanisms (including authentication and data integrity protection), but instead rely on the security features provided by higher layer 3GPP protocols (e.g., PDCP) for the aggregation traffic. However, at the same time the WLAN system routes non-aggregation local breakout traffic (e.g., to the Internet), which also needs to be secured.

The embodiments of the present invention, as described herein, provide a single WLAN access point that supports a first type of traffic routing to a first node (for example non-protected traffic routing to an aggregator, for example an eNB of a cellular network, while at the same time supporting a second type of traffic routing to a second node, (for example protected local breakout traffic routing for the same wireless device).

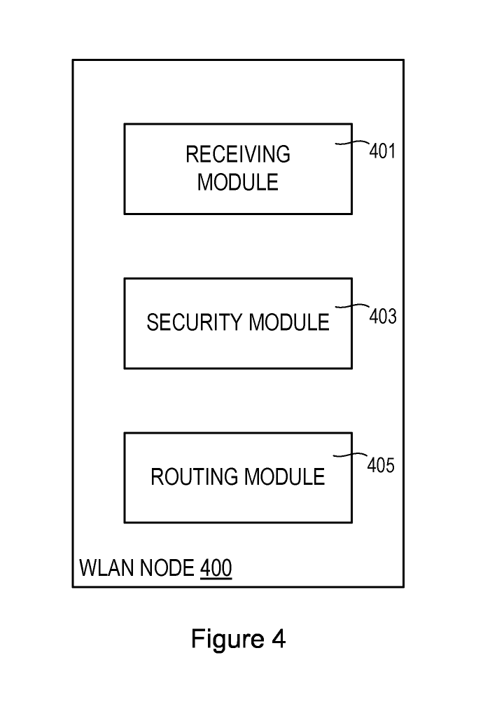

FIG. 4 shows an example of a wireless local area network, WLAN, node 400 according to an embodiment of the present invention. The WLAN node 400 is adapted to be comprised in an integrated wireless communications network comprising a WLAN and a cellular communications network. The WLAN node 400 comprises a receiving module 401, a security module 403 and a routing module 405. The receiving module 401 is adapted to receive traffic data signals from a wireless device. The security module 403 is adapted to process the received traffic data signals and apply a first security protocol to a first traffic data signal received from the wireless device and a second security protocol to a second traffic data signal received from the wireless device. The routing module 405 is adapted to route the first traffic data signal to a node of the cellular communications network and route the second traffic data signal to a node of the WLAN.

By being able to handle two traffic flows with different security levels (e.g. different security levels, or no security for 3GPP network traffic and security for local WLAN traffic), this enables the WLAN node 400 to handle both types of traffic simultaneously with the same wireless device.

As such, according to an embodiment of the present invention, there is provided a mechanism which allows a WLAN access node, or an Access Point (AP) to provide different security mechanisms for different traffic flows from the same user equipment or wireless device. For example, the WLAN node can employ no security (or OSA) for traffic that is routed towards a 3GPP aggregator node (e.g., an eNB, i.e. because this traffic already has its own in-build encryption) and at the same time use security for traffic that is intended for local breakout (e.g., the WLAN node can be a part of a Robust Security Network, RSN for the local breakout traffic).

According to one embodiment, the security module 403 is adapted to concurrently process the first traffic data signal and second traffic data signal from the same wireless device, and the routing module 405 is adapted to concurrently route the first traffic data signal and the second traffic data signal to their respective nodes. By concurrently it is meant that the WLAN node 400 is able to handle at least first and second traffic data signals at the same time with the same wireless device, and wherein the at least first and second traffic data signals are protected using different security or protection mechanisms. The references to concurrently do not necessarily require the processing to be carried out exactly in parallel or simultaneously, but include being able to process the different types of traffic data signals in an interleaved manner during a communication session between a wireless device and a WLAN node. In an example where a WLAN node 400 is able to handle at least first and second traffic data signals simultaneously with the same wireless device, this may involve, for example, using different frequencies for the different traffic types, such that the transmission of both traffic types is in parallel.

According to one embodiment the first security protocol comprises a security mechanism which is different to the security mechanism of the second security protocol. In one embodiment, the first security protocol comprises a security mechanism which has a lower level of security than the second security protocol, or vice versa. In one embodiment, the first security protocol comprises a level of encryption that is lower than a level of encryption of the second security protocol, or vice versa, In another embodiment, the first security protocol comprises a level of authentication which is lower than the level of authentication of the second security protocol, or vice versa.

For example, the first security protocol may comprise an Open System Authentication, OSA, security protocol.

In another example, the first security protocol comprises no additional security over and above a security protocol already provided in a received first traffic data signal. For example, if the first traffic data signal comprises cellular type traffic already comprising some from of encryption (for example aggregation traffic), the security module 403 is able to process that first traffic data signal without adding any further form of protection or security, and route the first traffic data signal to a node of a cellular network, e.g. an aggregation node.

In one example, the second security protocol comprises a Robust Secure Network, RSN, security protocol.

When two different security mechanisms are applied to two different traffic flows, an embodiment of the invention includes the option to derive the security associations from two different authentication protocol runs (potentially using separate credentials for the authentication).

According to a further aspect of the present invention, the security module 403 is further adapted to advertise the concurrent authentication capabilities of the WLAN node to other nodes or devices. For example, in this way a WLAN node 400, such as an Access Point, can indicate to other devices (such as a wireless device) that it can handle different types of traffic simultaneously, for example aggregation traffic and local breakout traffic simultaneously.

In one embodiment the security module 403 is adapted to advertise that it supports Robust Secure Network, RSN, authentication as the form of second security protocol for the second traffic data signals being routed to a node of the WLAN, and unencrypted communication as the first security protocol for the first traffic data signals being routed to a node of the cellular communications network. In this manner a WLAN node can advertise that it supports RSN authentication for local break out traffic when aggregation is ongoing.

In this example a WLAN node 400 can therefore advertise that it supports two authentication types, for example by advertising the RSN Element (RSNE) when it is part of a RSN, and besides this also advertising that it supports exchange of unencrypted aggregation traffic.

The security module 403 may be adapted to advertise its first security protocol capability and/or second security protocol capability using, for example, an information element comprising an Aggregation Security Element, ASG. In another example the security module 403 is adapted to advertise its first security protocol capability and/or second security protocol capability using a modified Robust Secure Network element, RSNE.

With regard to delivery of the advertisement, according to one embodiment, the security module 403 is adapted to advertise its first security protocol capability and/or second security protocol capability using an information element provided within a data frame, or a beacon signal, or a probe request response signal, or an authentication request/response signal, or a vendor specific information element. As such, an ASE can be specified, for example, as an IEEE 802.11 Information Element or as a vendor specific element (if for example it is defined in organizations outside of IEEE, e.g., the Wi-Fi Alliance, WFA).

Examples of the type of information that may be contained in the ASE are shown below:
Aggregation traffic is exchanged without over-the-air encryption, no additional authentication required;
Aggregation traffic is exchanged without over-the-air encryption, additional authentication required;
Aggregation traffic is exchanged with over-the-air encryption;
Aggregation traffic is exchanged with over-the-air encryption, provided by RSN mechanisms;
Information pertaining to the type of authentication and data integrity mechanisms used (e.g., cypher suits).

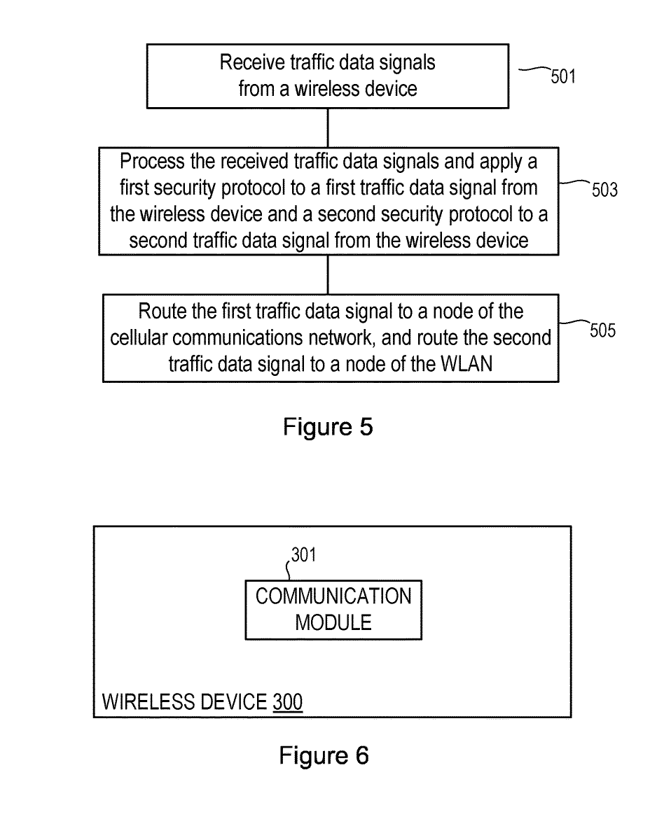

FIG. 5 shows a method in a wireless local area network, WLAN, node according to another embodiment of the present invention, the WLAN node being adapted to be comprised in an integrated wireless communications network comprising a WLAN and a cellular communications network. The method comprises receiving traffic data signals from a wireless device, step 501. The received traffic data signals are processed, and a first security protocol applied to a first traffic data signal received from the wireless device and a second security protocol applied to a second traffic data signal received from the wireless device, step 503. The first traffic data signal is routed to a node of the cellular communications network and the second traffic data signal routed to a node of the WLAN, step 505.

In one embodiment, the first traffic data signal and the second traffic data signal are processed concurrently to apply the first and second security protocols, and routed concurrently to their respective nodes. As mentioned above, by concurrently it is meant that the WLAN node is able to handle at least first and second traffic data signals at the same time with the same wireless device, and wherein the at least first and second traffic data signals are protected using different security or protection mechanisms. The references to concurrently do not necessarily require the processing to be carried out in parallel or simultaneously, but include being able to process the different types of traffic data signals in an interleaved manner during a communication session between a wireless device and a WLAN node.

The method may comprise the step of advertising concurrent authentication capabilities of the WLAN node to other nodes or devices.

FIG. 6 shows a wireless device 300 according to an embodiment of the present invention. The wireless device 300 comprises a communication module 301 adapted to communicate traffic data signals with a wireless local area network, WLAN, node. The communication module 301 is adapted to communicate a first traffic data signal using a first security protocol, and communicate a second traffic data signal using a second security protocol.

The wireless device 300 is adapted to communicate first and second traffic data signals with the same WLAN node concurrently, the first and second traffic data signals having different security protocols.

In one embodiment, the communication module 301 may be adapted to communicate the first traffic data signal using a first security protocol which comprises non-encrypted communication, and communicate the second traffic data signal using a second security protocol which comprises a Robust Secure Network, RSN, authentication procedure.

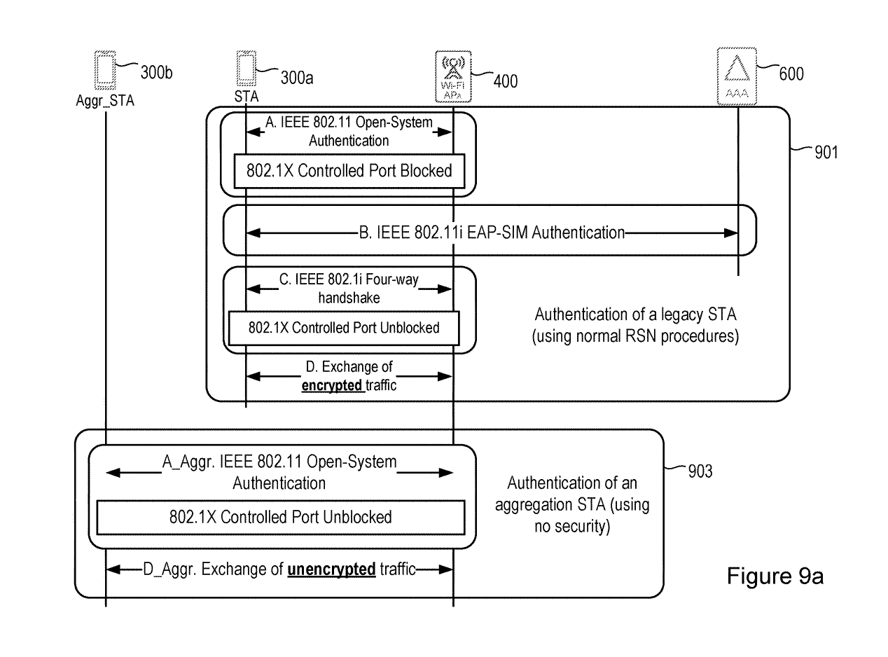

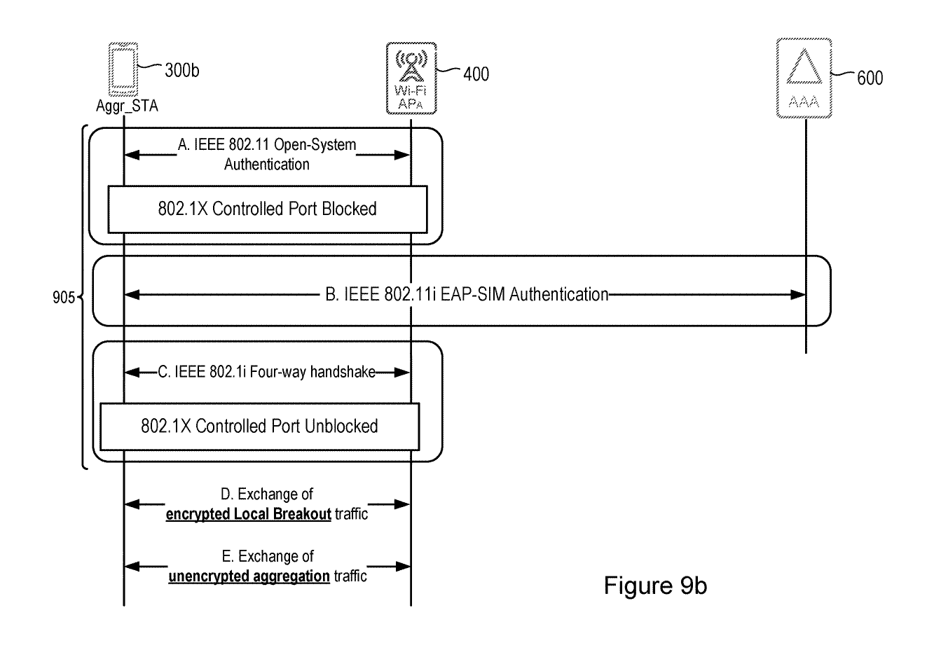

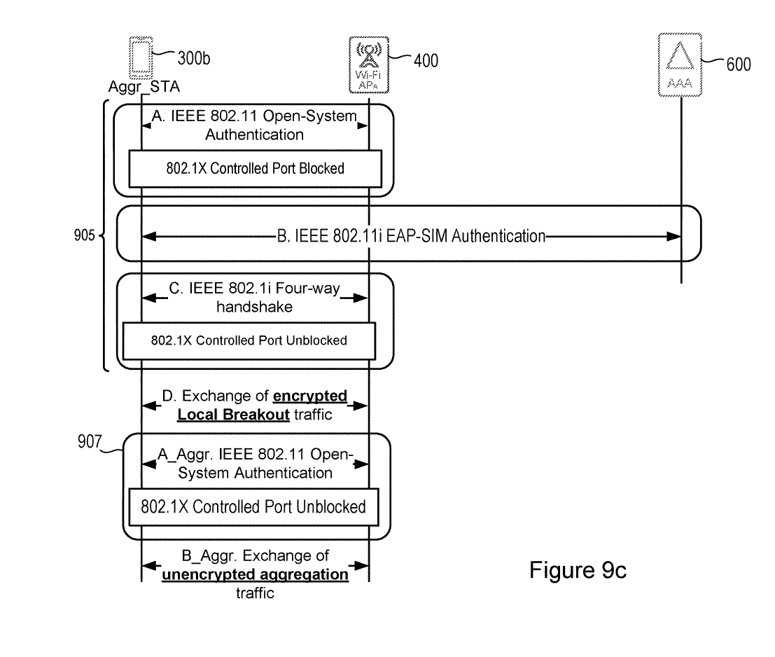

For example, in this manner, the wireless device may associate with a WLAN node using RSN authentication only, and send only cellular or 3GPP data (e.g. aggregation frames) without over-the-air-encryption, such that there is no need to change the existing standard, i.e. since the wireless device only uses RSN with a WLAN node. Further details of such an embodiment will be described later in connection with FIGS. 9a and 9b.

In another embodiment, the communication module 301 is adapted to communicate the first traffic data signal using a first security protocol which comprises Open System Authentication, OSA, and communicate the second traffic data signal using a second security protocol which comprises a Robust Secure Network, RSN, authentication procedure. Here, a wireless device is able to authenticate with a WLAN node using several different authentication mechanisms concurrently. For example, OSA is used for traffic which is ultimately forwarded by a WLAN node (Access Point) to a 3GPP node, and RSN for traffic which is ultimately forwarded by an Access Point to a local WLAN node. Further details of this embodiment will be described further below in relation to FIG. 9c.

The communication module 301 may be adapted to communicate the first and second traffic data signals using the first and second security protocols, in response to previously receiving an advertisement from the WLAN node, indicating the capability of the WLAN node to receive the first and second traffic data signals having different security protocols.

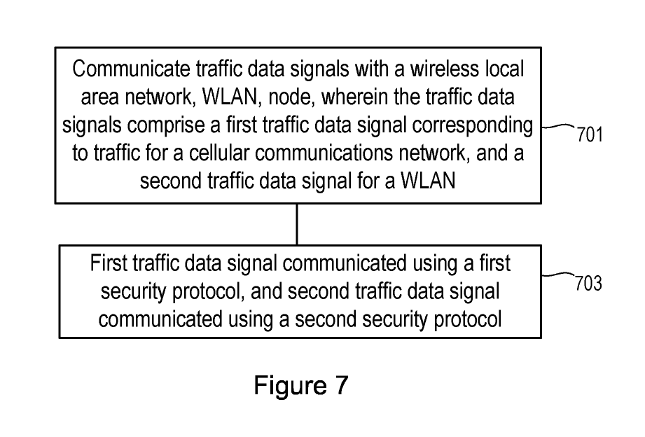

FIG. 7 shows a method in a wireless device, according to another embodiment of the present invention. The method comprises communicating traffic data signals with a wireless local area network, WLAN, node, wherein the traffic data signals comprise a first traffic data signal corresponding to traffic for a cellular communications network, and a second traffic data signal for a WLAN, step 701. The first traffic data signal is communicated using a first security protocol, and the second traffic data signal communicated using a second security protocol, step 703.

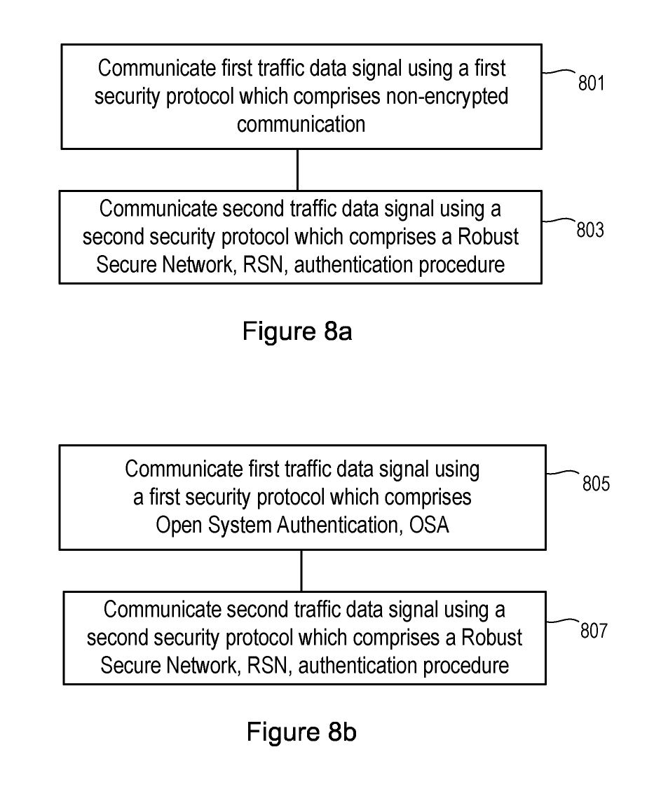

According to one embodiment illustrated in FIG. 8a, the method comprises the steps of communicating the first traffic data signal using a first security protocol which comprises non-encrypted communication, step 801, and communicating the second traffic data signal using a second security protocol which comprises a Robust Secure Network, RSN, authentication procedure, step 803. Further details of such an embodiment will be described later in connection with FIGS. 9a and 9b.

According to another embodiment illustrated in FIG. 8b, the method comprises communicating the first traffic data signal using a first security protocol which comprises Open System Authentication, OSA, step 805, and communicating the second traffic data signal using a second security protocol which comprises a Robust Secure Network, RSN, authentication procedure, step 807. Further details of this embodiment will be described further below in relation to FIG. 9c.

FIG. 9a shows an example message flow for the authentication of a legacy wireless device 300a and an aggregation wireless device 300b. It is noted that, to simplify the flow-chart in FIG. 9a, the aggregation wireless device 300b is not shown running any local break out traffic flows. In this case, the WLAN node 400 will need to be able to make a difference between a legacy wireless device 300a and an aggregation wireless device 300b (whereby a wireless device will need to report its aggregation capabilities to the WLAN node 400, for example as described in PCT/SE2014/51262 by the present Applicant). In FIG. 9a, the exchange of message flows bounded by the dotted box 901 relate to those of authentication with a legacy wireless device 300a using, for example, normal RSN procedures, while the exchange of message flows bounded by dotted box 903 relate to authentication of an aggregation wireless device 300b, whereby aggregation traffic is exchanged between the WLAN node 400 and the aggregation wireless device 300b using, for example, no security. As mentioned above, according to embodiments of the present invention, the aggregation device 300b is also be able to communicate with the WLAN node 400 using a different security protocol, for example RSN authentication, as will be described further in FIGS. 9b and 9c.

Referring to FIG. 9b, this expands on the message flows of the aggregation wireless device 300b of FIG. 9a, and shows an example of message flows corresponding to the option described above in FIG. 8a, i.e. whereby a wireless device 300 associates to a WLAN node (e.g. AP) using just one security protocol, for example RSN authentication, and then sends only the first traffic data signal flows, for example cellular type traffic, such as aggregation frames, without over-the-air encryption. The message flows labeled 905 correspond to the wireless device 300b setting up a security protocol with the WLAN node 400, for example setting up an RSN authentication. Then, local breakout traffic is exchanged using this security protocol, such that encrypted local breakout traffic is exchanged between the wireless device 300b and the WLAN node 400. However, aggregation traffic is exchanged in unencrypted mode, e.g. since no encryption is required because the aggregation traffic already has its own in-built security mechanism.

FIG. 9c shows an example according to another embodiment, corresponding to the embodiment described above in FIG. 8b. This embodiment supports two (or more) different concurrent authentications between a single WLAN node 400 and a single wireless device or user equipment (station) 300b, for example a WLAN node that supports both OSA and RSN simultaneously. Therefore, a wireless device 300b can authenticate and associate to said WLAN node using either security mechanism, or in the case where they are aggregating wireless devices, both security mechanisms simultaneously. The message flows labeled 905 correspond to the wireless device 300b setting up a first security protocol with the WLAN node 400, for example setting up an RSN authentication, and the message flows 907 correspond to the wireless device 300b setting up a second security protocol with the WLAN node 400, for example setting up OSA.

Thus, in the example of FIG. 9c a wireless device is provided with the option of authenticating to a WLAN node (AP) using several different authentication mechanisms concurrently, e.g. one OSA and one RSN. The scenario is similar to the one in FIG. 9b, but the process flow is different. In this case, the wireless device 300b will use two different authentications simultaneously—one for the local breakout traffic and one for the aggregation traffic. This option may be implemented in IEEE 802.11 standards, by allowing for one wireless device 300 to have multiple concurrent authentications to the same WLAN node or access point. In this case, the WLAN node is adapted to maintain two different state machines, one for each type of traffic. The WLAN node can advertise the requirement for a wireless device to complete two or more authentications, for example in the ASE as mentioned above.

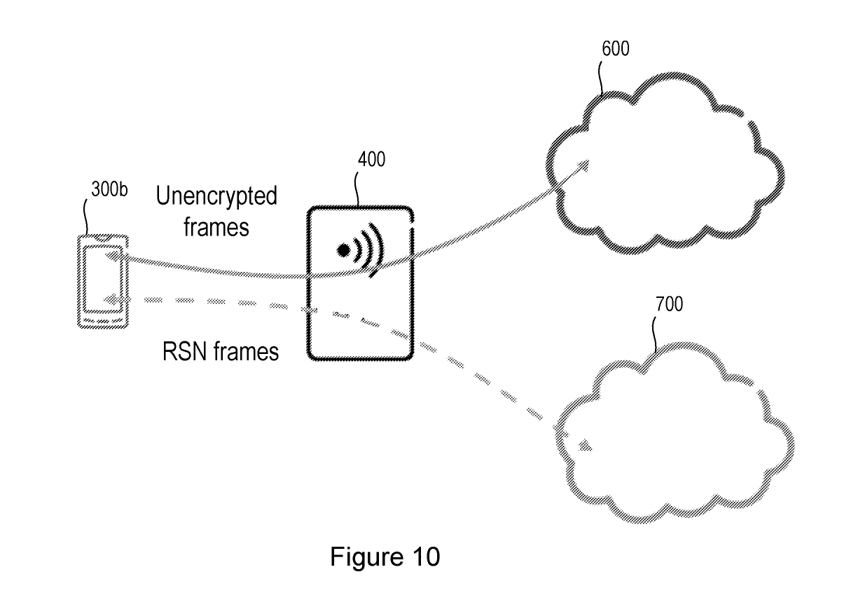

FIG. 10 shows an example of a network comprising a WLAN node 400 (such as an access point) and a wireless device 300 according to embodiments described herein. The WLAN node 400 is able to still provide secure communication to legacy wireless devices as usual, for example by using a second security protocol, such as RSN frames in the example, for local breakout traffic, for example WLAN traffic which is being routed to the Internet 700. However, as discussed above, for aggregation wireless devices 300b that send aggregation traffic, such traffic can be exchanged between the WLAN 400 and the wireless device 300 without over-the-air encryption. This option illustrated in the example of FIG. 10 has no impact on legacy wireless devices, since they will observe the WLAN node 400 as a normal RSN WLAN node.

According to the embodiments described herein, two different traffic types that a wireless station has, for example aggregation traffic and local breakout traffic, are treated differently when it comes to security.

An embodiment provides a method of operating a WLAN access point capable of maintaining a first and a second protection mechanism with a wireless device. In one embodiment a method comprises announcing which protection mechanisms are supported by the WLAN access point, protecting a first type of traffic received from the device using the first protection mechanism, protecting a second type of traffic received from the device using the second protection mechanism, and forwarding the first type of traffic to a 3GPP aggregation function.

According to another aspect of the present invention, there is provided a computer program, comprising instructions which, when executed on at least one processor, causes the at least one processor to carry out the method according to any one of the embodiments described above, and as defined in the appended claims.

According to another aspect of the present invention, there is provided a carrier comprising such a computer program, wherein the carrier is one of an electronic signal, optical signal, radio signal or computer readable storage medium.

It is noted that the embodiments described can overcome a problem whereby a WLAN AP has to provide capabilities and route traffic for two different purposes: one for the 3GPP aggregation and one for the local break out (e.g., Internet traffic or access to a home or enterprise network). Since the 3GPP aggregation traffic is secured by higher player protocols (i.e., the PDCP) no security (or lower form of security) is needed over the WLAN air interface for the traffic that is routed towards the 3GPP aggregator (the traffic between the WLAN AP and the 3GPP aggregator could be protected by, e.g., IPsec to ensure that only traffic from authorized APs are allowed to reach the 3GPP aggregator). In the case no security is applied to the aggregation flow over-the-air, the WLAN AP can be configured to use OSA for authentication for these flows. In the embodiments a WLAN AP is able to separate between which flows are aggregation flows. However, the local breakout traffic is not protected by 3GPP security, and hence the WLAN AP is able to provide security for this traffic over the air interface.

In the embodiments described above the first traffic data signal is described as comprising at least part of an aggregation signal for a cellular communications network, and the second traffic data signal described as comprising a local breakout signal of the WLAN. It is noted, however, that the first and second traffic data signals may comprise any form of different traffic signals.

The embodiments of the present invention allow the same user equipment, wireless device or station to run some flows as aggregation flows and other flows as local break out flows, i.e. simultaneously from the same user equipment.

The embodiments describe a mechanism which allows a WLAN access node, or an Access Point (AP) to provide different security mechanisms for different traffic flows from the same user equipment or wireless device. For example, the AP can employ no security (or OSA) for traffic that is routed towards a 3GPP aggregator node (e.g., an eNB) and at the same time use security for traffic that is intended for local breakout (e.g., the AP can be a part of a Robust Security Network, RSN for the local breakout traffic).

The embodiments of the present invention therefore provide a technical solution, which enables a network node, such as a WLAN access point, to allow for multiple different authentications simultaneously towards a single user equipment or station or wireless device. As such, it can be assured that local breakout traffic is secured in terms of confidentiality and integrity, without imposing unnecessary security processing on other traffic, such as aggregation traffic, which already has sufficient security an integrity.

Although the embodiments refer to supporting first and second security protocols, it is noted that a wireless device may support several authentications to the same WLAN node or access point simultaneously:

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-22. (canceled)

23. A method in a wireless local area network (WLAN) node adapted to be comprised in an integrated wireless communications network comprising a WLAN and a cellular communications network, the method comprising:
receiving traffic data signals from a wireless device;
processing the received traffic data signals and applying a first security protocol to a first traffic data signal received from the wireless device and a second security protocol to a second traffic data signal received from the wireless device; and
routing the first traffic data signal to a node of the cellular communications network and routing the second traffic data signal to a node of the WLAN.

24. The method of claim 23, wherein the first traffic data signal and the second traffic data signal are processed concurrently to apply the first and second security protocols, and routed concurrently to their respective nodes.

25. The method of claim 23, wherein:
the first security protocol comprises a security mechanism which is different to the security mechanism of the second security protocol; or
the first security protocol comprises a security mechanism which has a lower level of security than the second security protocol, or vice versa
the first security protocol comprises a level of encryption that is lower than a level of encryption of the second security protocol, or vice versa; or
the first security protocol comprises a level of authentication which is lower than the level of authentication of the second security protocol, or vice versa.

26. The method of claim 23, wherein the first security protocol comprises an Open System Authentication (OSA) security protocol.

27. The method of claim 23, wherein the first security protocol comprises no additional security over and above a security protocol already provided in a received first traffic data signal.

28. The method of claim 23, wherein the second security protocol comprises a Robust Secure Network (RSN) security protocol.

29. The method of claim 23, further comprising the step of advertising authentication capabilities of the WLAN node to other nodes or devices.

30. A wireless local area network (WLAN) node adapted to be comprised in an integrated wireless communications network comprising a WLAN and a cellular communications network, the WLAN node comprising:
a receiver configured to receive traffic data signals from a wireless device;
a processor; and
a memory operatively coupled to the processor and storing instructions for execution by the processor, whereby the WLAN node is configured to:
process the received traffic data signals and apply a first security protocol to a first traffic data signal received from the wireless device and a second security protocol to a second traffic data signal received from the wireless device; and
route the first traffic data signal to a node of the cellular communications network and route the second traffic data signal to a node of the WLAN.

31. The WLAN node of claim 30, wherein the WLAN node is configured to concurrently process the first traffic data signal and second traffic data signal from the same wireless device, and to concurrently route the first traffic data signal and the second traffic data signal to their respective nodes.

32. The WLAN node of claim 30, wherein:
the first security protocol comprises a security mechanism which is different to the security mechanism of the second security protocol; or
the first security protocol comprises a security mechanism which has a lower level of security than the second security protocol, or vice versa
the first security protocol comprises a level of encryption that is lower than a level of encryption of the second security protocol, or vice versa; or
the first security protocol comprises a level of authentication which is lower than the level of authentication of the second security protocol, or vice versa.

33. The WLAN node of claim 30, wherein the first security protocol comprises an Open System Authentication (OSA) security protocol.

34. The WLAN node of claim 30, wherein the first security protocol comprises no additional security over and above a security protocol already provided in a received first traffic data signal.

35. The WLAN node of claim 30, wherein the second security protocol comprises a Robust Secure Network (RSN) security protocol.

36. The WLAN node of claim 30, wherein the WLAN node is further configured to advertise concurrent authentication capabilities of the WLAN node to other nodes or devices.

37. The WLAN node of claim 36, wherein the WLAN node is configured to advertise that it supports:
Robust Secure Network (RSN) authentication as the form of second security protocol for the second traffic data signals being routed to a node of the WLAN; and
unencrypted communication as the first security protocol for the first traffic data signals being routed to a node of the cellular communications network.

38. The WLAN node of claim 36, wherein the WLAN node is configured to advertise its first security protocol capability and/or second security protocol capability using:
an information element comprising an Aggregation Security Element (ASG); or
a modified Robust Secure Network element (RSNE).

39. The WLAN node of claim 38, wherein the WLAN node is configured to advertise its first security protocol capability and/or second security protocol capability using:
an information element provided within a data frame, or a beacon signal, or a probe request response signal, or an authentication request/response signal; or
a vendor specific information element.

40. The WLAN node of claim 30, wherein the first traffic data signal comprises at least part of an aggregation signal for a cellular communications network, and wherein the second traffic data signal comprises a local breakout signal of the WLAN.

41. A method in a wireless device, the method comprising:
communicating traffic data signals with a wireless local area network (WLAN) node, wherein the traffic data signals comprise a first traffic data signal corresponding to traffic for a cellular communications network, and a second traffic data signal for a WLAN;
wherein the first traffic data signal is communicated using a first security protocol, and the second traffic data signal communicated using a second security protocol.

42. The method of claim 41, further comprising:
communicating the first traffic data signal using a first security protocol which comprises non-encrypted communication, and communicating the second traffic data signal using a second security protocol which comprises a Robust Secure Network (RSN) authentication procedure; or
communicating the first traffic data signal using a first security protocol which comprises Open System Authentication (OSA) and communicating the second traffic data signal using a second security protocol which comprises a Robust Secure Network (RSN) authentication procedure.

43. The method of claim 41, wherein the method comprises:
communicating the first traffic data signal using a first security protocol which comprises Open System Authentication (OSA); and
communicating the second traffic data signal using a second security protocol which comprises a Robust Secure Network (RSN) authentication procedure.

44. The method of claim 41, wherein method comprises communicating the first and second traffic data signals, using the first and second security protocols, in response to previously receiving an advertisement from the WLAN node, the advertisement indicating the capability of the WLAN node to receive the first and second traffic data signals having different security protocols.

45. A wireless device comprising:
a communication module configured to communicate traffic data signals with a wireless local area network (WLAN) node, the communication module comprising a processor and a memory operatively coupled to the processor and storing instructions for execution by the processor, whereby the communication module is configured to:
communicate a first traffic data signal using a first security protocol; and
communicate a second traffic data signal using a second security protocol.

46. A wireless device as claimed in claim 45, wherein the communication module is adapted to:
communicate the first traffic data signal using a first security protocol which comprises non-encrypted communication; and
communicate the second traffic data signal using a second security protocol which comprises a Robust Secure Network (RSN) authentication procedure.

47. A wireless device as claimed in claim 45, wherein the communication module is adapted to:
communicate the first traffic data signal using a first security protocol which comprises Open System Authentication (OSA); and
communicate the second traffic data signal using a second security protocol which comprises a Robust Secure Network (RSN) authentication procedure.

48. A wireless device as claimed in claim 45, wherein the communication module is adapted to communicate the first and second traffic data signals, using the first and second security protocols, in response to previously receiving an advertisement from the WLAN node, the advertisement indicating the capability of the WLAN node to receive the first and second traffic data signals having different security protocols.

49. A non-transitory computer-readable medium comprising, stored thereupon, a computer program comprising instructions that, when executed on at least one processor of a wireless local area network (WLAN) node adapted to be comprised in an integrated wireless communications network comprising a WLAN and a cellular communications network, causes the at least one processor to:
receive traffic data signals from a wireless device;
process the received traffic data signals and apply a first security protocol to a first traffic data signal received from the wireless device and a second security protocol to a second traffic data signal received from the wireless device; and
route the first traffic data signal to a node of the cellular communications network and routing the second traffic data signal to a node of the WLAN.

50. A non-transitory computer-readable medium comprising, stored thereupon, a computer program comprising instructions that, when executed on at least one processor of a wireless device, causes the at least one processor to:
communicate traffic data signals with a wireless local area network (WLAN) node, wherein the traffic data signals comprise a first traffic data signal corresponding to traffic for a cellular communications network, and a second traffic data signal for a WLAN;
such that the first traffic data signal is communicated using a first security protocol, and the second traffic data signal communicated using a second security protocol.
